(19) United States
(12) Patent Application Publication
(10) Pub. No.: US 2013/0089314 A1
(43) Pub. Date: Apr. 11, 2013

(54) POWER SUPPLYING APPARATUS, POWER SUPPLYING METHOD, AND IMAGING APPARATUS

(71) Applicant: Kimiyasu NAMEKAWA, Tokyo (JP)

(72) Inventor: Kimiyasu NAMEKAWA, Tokyo (JP)

(73) Assignee: Sony Corporation, Tokyo (JP)

(21) Appl. No.: 13/585,418

(22) Filed: Aug. 14, 2012

(30) Foreign Application Priority Data
Oct. 5, 2011 (JP) 2011-220817

(51) Int. Cl. H02P 1/18; G03B 17/00

(52) U.S. Cl. 396/301; 318/139

(57) ABSTRACT

A power supplying apparatus includes: a capacitor that is connected in parallel with a battery; a voltage control apparatus configured to control a voltage for charging the capacitor; a current limiting circuit configured to control a current amount to be supplied to the capacitor; a first switching element configured to control supply of a current for charging the capacitor; and a second switching element configured to control supply of a current from the capacitor to at least one motor.

### BACKGROUND

The present disclosure relates to a power supplying apparatus, a power supplying method, and an imaging apparatus. In particular, the present disclosure relates to a power supplying apparatus and a power supplying method for increasing an operating time of an electronic apparatus such as an imaging apparatus including a motor in a load circuit.

In recent years, a mobile electronic apparatus typified by a digital still camera, a digital video camera, a digital single-lens camera, a mobile phone, a portable audio player, and the like has been remarkably more advanced in functionality. Moreover, there has been a growing demand for more advanced functionality of the mobile electronic apparatus from a user of the mobile electronic apparatus with dramatically higher demand for the mobile electronic apparatus. Further, the demand for downsizing the mobile electronic apparatus from the user of the mobile electronic apparatus is also highly growing.

Downsizing the mobile electronic apparatus also needs to downsize a battery used as a power supply of the mobile electronic apparatus. Therefore, while power consumption increases with the advanced functionality of the mobile electronic apparatus, a developer of the mobile electronic apparatus is in such a state that a battery capacity of the battery mounted on the mobile electronic apparatus is hardly expected to increase.

For example, in a case of the digital still camera, when the battery capacity is decreased by downsizing the battery, the number of pictures that can be captured in the digital still camera is reduced. Accordingly, on the assumption that the battery having a predetermined capacity is used, an attempt has been made to increase the number of pictures that can be captured in the digital still camera.

As a method for prolonging the operating time of the mobile electronic apparatus, several methods have been proposed.

For example, a first method is a method of reducing power consumption of the mobile electronic apparatus itself. However, since the reduction of the power consumption of the mobile electronic apparatus itself and the advanced functionality of the mobile electronic apparatus are in a tradeoff relation, employing the first method is generally not practical.

A second method is a method of smoothing, as much as possible, change in a terminal voltage (a descending curve in a discharge curve) near a discharge termination voltage of the battery. According to the second method, the capacity of the battery can be used as much as possible, but the change in the terminal voltage near the discharge termination voltage of the battery is one of intrinsic characteristics of the battery, and an electrode material and the like of the battery need to be developed. Therefore, a new battery needs to be developed to employ the second method and the cost for the development of the battery increases.

A third method is a method of reducing a voltage (hereinafter, appropriately referred to as a “stop voltage”), as much as possible, which terminates an operation of the mobile electronic apparatus. The stop voltage of the mobile electronic apparatus is reduced and is made as close as possible to the discharge termination voltage of the battery, so that a range of the capacity of the battery in which the battery can be used is increased, which results in increasing a driving time of the mobile electronic apparatus. The third method is a method for using a battery having a predetermined capacity efficiently and is extremely cost effective in a development of the mobile electronic apparatus such as the digital still camera.

The stop voltage of the mobile electronic apparatus is determined based on a lower limit of an input voltage range of an integrated circuit (IC) included in the load circuit of the mobile electronic apparatus. To enable the mobile electronic apparatus to operate correctly, it is necessary that an input voltage to be inputted to the load circuit from the battery does not fall below the stop voltage of the mobile electronic apparatus.

In this case, the battery has an internal resistance and the like, a terminal voltage of the battery during an operation of the mobile electronic apparatus is changed in accordance with a current amount flowing through the load circuit of the mobile electronic apparatus. Therefore, when the current amount flowing through the load circuit of the mobile electronic apparatus increases momentarily, the terminal voltage of the battery momentarily decreases greatly.

That is, to enable the mobile electronic apparatus to operate correctly, it is necessary that a voltage applied to the IC do not fall below the lower limit of the input voltage range of the IC even when the current amount flowing through the load circuit increases momentarily and the terminal voltage of the battery momentarily decreases greatly. In other words, if the momentary decrease in the terminal voltage of the battery with the momentary increase in the current amount flowing through the load circuit can be suppressed, the stop voltage of the mobile electronic apparatus can be decreased.

As a method of suppressing the momentary decrease in the terminal voltage of the battery with the momentary increase in the current amount flowing through the load circuit, a method of connecting a capacitor having a low equivalent series resistance in parallel with the battery has been known, for example.

Japanese Patent Application Laid-Open No. 2008-206357 discloses a power supplying apparatus that prevents excessive voltage from being applied to a battery connected in parallel with a capacitor by turning off a switch when the switch is provided at a connection point between the battery and the capacitor and a voltage of the capacitor is higher than a voltage of the battery. Moreover, Japanese Patent No. 3526028 discloses a power supply circuit that compares a current amount flowing through a load circuit and a voltage of a capacitor with setting values and determines which one of a battery and the capacitor supplies power in accordance with a magnitude relationship therebetween.

### SUMMARY

It is desirable to prolong the driving time of the mobile electronic apparatus.

According to a first favorable embodiment of the present disclosure, there is provided a power supplying apparatus, including: a capacitor; a voltage control apparatus; a current limiting circuit; a first switching element; and a second switching element.

The capacitor is connected in parallel with the battery.

The voltage control apparatus is configured to control a voltage for charging the capacitor.

The current limiting circuit is configured to control a current amount to be supplied to the capacitor.

The first switching element is configured to control supply of a current for charging the capacitor.

The second switching element is configured to control supply of a current from the capacitor to at least one motor.

According to a second favorable embodiment of the present disclosure, there is provided a power supplying method, including: turning on a first switching element during a stop of discharging a capacitor and charging the capacitor by a battery connected in parallel with the capacitor through a voltage control apparatus and a current limiting circuit; and turning on a second switching element at a start of operating one of at least one motor included in a load circuit and supplying, from the capacitor, power to the motor caused to start operating.

According to a third favorable embodiment of the present disclosure, there is provided an imaging apparatus, including: one or more motors; a capacitor; a voltage control apparatus; a current limiting circuit; a first switching element; a second switching element; and a control unit.

The one or more motors are configured to drive at least one of a lens, a diaphragm, a mirror, and a shutter.

The capacitor is connected in parallel with a battery.

The voltage control apparatus is configured to control a voltage for charging the capacitor.

The current limiting circuit is configured to control a current amount to be supplied to the capacitor.

The first switching element is configured to control supply of a current for charging the capacitor.

The second switching element is configured to control supply of a current from the capacitor to one or more motors.

The control unit is configured to control one of turn-on and turn-off of the first switching element and the second switching element.

In the present disclosure, for example, when the motor included in the load circuit is driven, the capacitor connected in parallel with the battery is supplied power to the motor included in the load circuit with respect to the momentary increase in a load current. Therefore, the momentary increase of the current flowing from the battery is prevented and the momentary decrease in the terminal voltage of the battery is suppressed. Since the momentary decrease in the terminal voltage of the battery is suppressed, the stop voltage of an electronic apparatus can be decreased and the driving time of the electronic apparatus is increased.

In the present disclosure, the capacitor is charged from the battery connected in parallel with the capacitor through the voltage control apparatus. Therefore, the voltage of the capacitor after being charged does not depend on the terminal voltage of the battery and the voltage of the capacitor is not fluctuated in a fully charged state. Since the voltage of the capacitor is not fluctuated in the fully charged state, the operation of the motor included in the load circuit is stable.

In the present disclosure, the capacitor is changed from the battery connected in parallel with the capacitor through the current limiting circuit. Therefore, even if the capacitor is charged when an amount of electric charge accumulated in the capacitor is small, an inrush current does not flow from the battery to the capacitor. That is, even if the capacitor is charged when the amount of electric charge accumulated in the capacitor is small, a rapid decrease in the terminal voltage of the battery is prevented.

According to at least one embodiment, it is possible to increase a driving time of an electronic apparatus such as an imaging apparatus including a motor in a load circuit.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a configuration example of an imaging apparatus according to an embodiment;

FIG. 2 is a block diagram showing a configuration example of a power supplying apparatus according to the embodiment;

FIG. 3A is a circuit diagram showing an example of a constant current circuit, and FIG. 3B is a circuit diagram showing an example of a bi-directional switch;

FIG. 4 is a block diagram showing another configuration example of the power supplying apparatus according to the embodiment;

FIG. 5A is a diagram showing an example of a discharge curve of a capacitor, and FIG. 5B is a block diagram for explaining an example of control of the power supplying apparatus by a control unit;

FIG. 6 is a flowchart showing a flow of processing by the control unit;

FIG. 7A is a diagram for explaining a change of a current amount flowing through a motor when a voltage is applied to the motor, and FIG. 7B is a diagram showing an equivalent circuit of the motor; and

FIGS. 8A and 8B are diagrams each showing an example of a discharge curve of the battery.

### DETAILED DESCRIPTION OF EMBODIMENTS

In the following, an embodiment of a power supplying apparatus, a power supplying method, and an imaging apparatus will be described. The descriptions will be given below in the following order.
0. Relationship between discharge curve of battery and stop voltage of electronic apparatus
1. Embodiment
[Configuration example of imaging apparatus]

(Power supply unit)

(Control unit)

(Motor)
[Operation of imaging apparatus]
[Configuration of power supplying apparatus]

(Capacitor)

(Voltage control apparatus)

(Current limiting circuit)

(Switching elements)
[Another configuration example of power supplying apparatus]
[Example of control]
2. Modified examples

It should be noted that the embodiment described below is favorable specific examples of the power supplying apparatus, the power supplying method, and the imaging apparatus. In the following descriptions, various technically favorable limitations are applied to the embodiment. However, unless it is specifically described in the following descriptions that the present disclosure is limited, the examples of the power supplying apparatus, the power supplying method, and the imaging apparatus are not limited to the embodiment hereinafter described.

### 0. RELATIONSHIP BETWEEN DISCHARGE CURVE OF BATTERY AND STOP VOLTAGE OF ELECTRONIC APPARATUS

First, to help understand the embodiment of the present disclosure, a relationship between a discharge curve of a battery and a stop voltage of an electronic apparatus will be described. Hereinafter, it should be noted that an electronic apparatus that includes a motor in a load circuit and is driven by the battery as a power source is taken as an example.

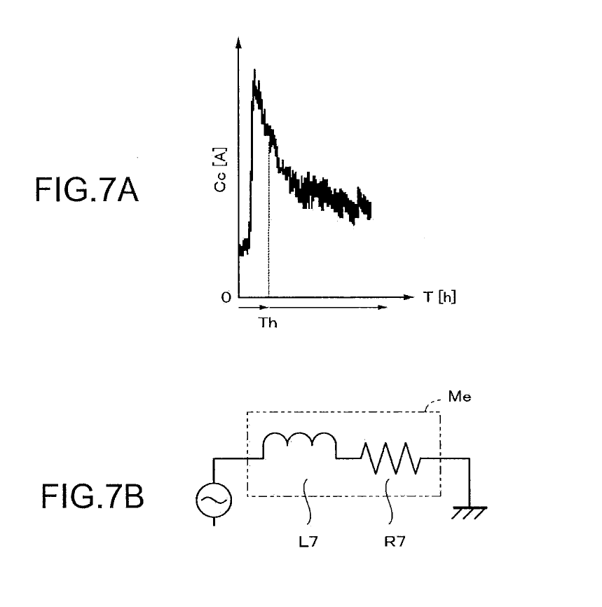

FIG. 7A is a diagram for explaining a change of a current amount flowing through the motor when a voltage is applied to the motor. FIG. 7B is a diagram showing an equivalent circuit of the motor. In FIG. 7A, a vertical axis represents a consumption current Cc [A] when the voltage is applied to the motor and a horizontal axis represents a motor driving time T [h] elapsing from a start of applying the voltage to the motor.

As shown in FIG. 7A, when the voltage is applied to the motor, the current amount flowing into the motor rapidly increases after the voltage is applied and then reduces gradually and is saturated at a certain point.

As shown in FIG. 7B, this is because an equivalent circuit Me of the motor has a component corresponding to an inductor L7 and a component corresponding to a resistor R7. That is, the motor can be considered as a resistor at an initial stage of applying the voltage to the motor, and an initial current determined by a wiring resistance of the resistor R7 flows into the motor. When the motor starts rotating, the current does not easily flow into the motor under the influence of a counter electromotive force by the inductor L7. Therefore, a consumption current amount at the time of applying the voltage to the motor has a peak at the initial stage of applying the voltage to the motor.

Since the consumption current amount at the time of applying the voltage to the motor has the peak at the initial stage of applying the voltage to the motor, for example, when an attempt is made to drive the motor by the battery as the power source, a large current flows out as the initial current from the battery at the initial stage of applying the voltage to the motor. Then, the battery has an internal resistance, so that the terminal voltage of the battery rapidly decreases by an amount corresponding to a voltage ΔVd proportional to the initial current.

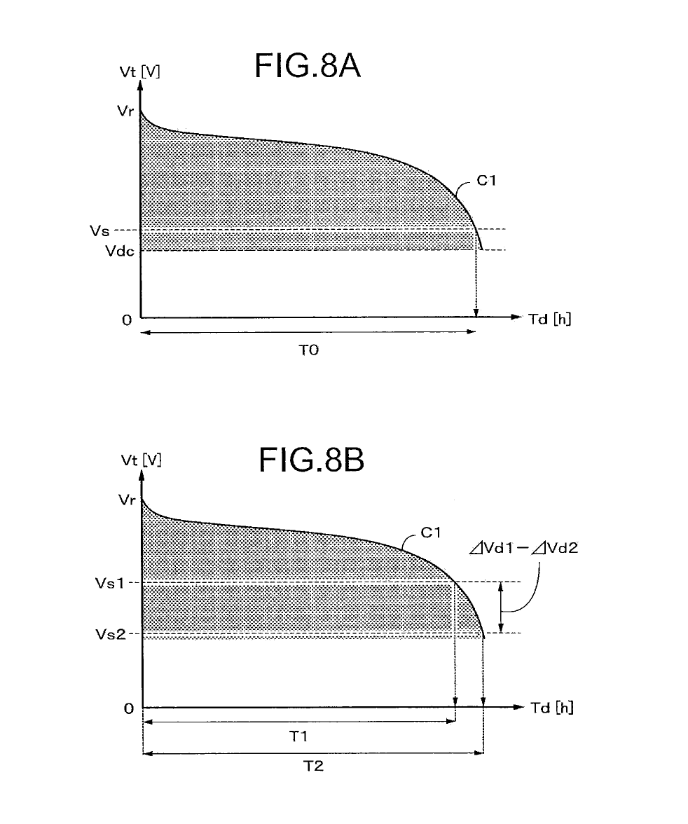

FIGS. 8A and 8B are diagrams showing an example of a discharge curve of the battery. In FIGS. 8A and 8B, a vertical axis represents a terminal voltage Vt [V] of the battery and a horizontal axis represents a time Td [h] when a current is extracted from the battery.

In FIGS. 8A and 8B, a solid curve C1 is a curve showing the discharge curve of the battery. As indicated by the solid curve C1, the terminal voltage of the battery gradually decreases from a rated voltage Vr as the discharge of the battery proceeds. In FIG. 8A, Vdc denotes a discharge termination voltage of the battery and an operation of the battery is guaranteed between the rated voltage Vr and the discharge termination voltage Vdc of the battery (a shaded region in FIGS. 8A and 8B) according to the standards.

In FIG. 8A, Vs denotes a stop voltage of the electronic apparatus. In general, in the electronic apparatus, a direct current to direct current (DC-DC) converter, a central processing unit (CPU), or the like include an IC. The IC has a lower limit in an input voltage range and when the voltage applied to the IC falls below the lower limit, the IC is shut down. That is, when the voltage applied to the IC falls below the lower limit, the operation of the electronic apparatus is suddenly stopped.

Therefore, the stop voltage Vs is set so that the voltage higher than the lower limit of the input voltage range of the IC can be ensured as the voltage applied to the IC. In general, even if Vs>Vdc is established as shown in FIG. 8A and the battery can be used up to the discharge termination voltage Vdc according to the standards of the battery, the electronic apparatus regards the battery as no capacity and prompts a user of the electronic apparatus to replace or charge the battery when the terminal voltage of the battery reaches the stop voltage Vs.

Although the solid curve C1 as shown in FIG. 8A is a curve showing a change in a voltage when a constant current is continuously flowed from the battery, an driving time of the electronic apparatus can be estimated from an intersection between the discharge curve of the battery and a straight line representing the stop voltage. For example, provided that the terminal voltage of the battery changes according to the curve C1, a time T0 until the terminal voltage of the battery reaches the stop voltage Vs corresponds to the driving time of the electronic apparatus.

As mentioned above, the electronic apparatus is designed so that the voltage applied to the IC is higher than the lower limit of the input voltage range of the IC in the operation of the electronic apparatus. In other words, even when the terminal voltage of the battery momentarily decreases with the momentary increase in the current amount flowing through the load circuit, the voltage higher than the lower limit of the input voltage range of the IC has to be ensured as the voltage applied to the IC.

In this case, when the electronic apparatus includes the motor in the load circuit and is driven by the battery as the power source, it is considered that a load current is largest at the initial stage of applying the voltage to the motor. Therefore, to prevent a sudden operation stop of the electronic apparatus, even if the terminal voltage of the battery decreases at the initial stage of applying the voltage to the motor, the voltage higher than the lower limit of the input voltage range of the IC has to be ensured as the voltage applied to the IC.

Now, suppose that the lower limit of the input voltage range of the IC is Vm and a decrement of the terminal voltage of the battery caused when the initial current starts flowing from the battery due to the start of driving the motor is ΔVd1.

At this time, it can be considered that the stop voltage of the electronic apparatus is approximately Vs1=Vm+ΔVd1+A (A is constant). In this case, it is assumed that one IC is included in the electronic apparatus.

Referring to FIG. 8B, when the driving time of the electronic apparatus is estimated from the intersection between the curve C1 and the straight line representing the stop voltage Vs1, a time until the terminal voltage of the battery reaches the stop voltage Vs1 is T1 shown in FIG. 8B.

Next, considering that the decrement of the terminal voltage of the battery is ΔVd2 (ΔVd2<ΔVd1), the stop voltage of the electronic apparatus at this time is approximately Vs2=Vm+ΔVd2+A, and Vs2<Vs1 is satisfied.

Similar to the above-described procedure, when the driving time of the electronic apparatus is estimated from the intersection between the curve C1 and the straight line representing the stop voltage Vs2, a time until the terminal voltage of the battery reaches the stop voltage Vs2 is T2 shown in FIG. 8B. As apparent from FIG. 8B, T2>T1 is satisfied.

That is, if the decrement of the terminal voltage of the battery can be reduced when the terminal voltage of the battery decreases due to the start of driving the motor, it is possible to extend the time until the terminal voltage of the battery reaches the stop voltage of the electronic apparatus. In other words, if the decrement of the terminal voltage of the battery due to the start of driving the motor can be reduced, it is possible to drive the electronic apparatus by the battery for longer periods of time.

A time until the current at the initial stage of applying the voltage to the motor is saturated to a constant current depends on the voltage applied to the motor, a wiring resistance of the motor, and the number of windings of the motor, but is generally a very short time of about several tens [ms]. That is, if power is not supplied from the battery to the motor in a very short time for flowing the initial current into the motor, a maximum value of the current flowing from the battery can be reduced and the driving time of the electronic apparatus is increased.

### 1. EMBODIMENT

### CONFIGURATION EXAMPLE OF IMAGING APPARATUS

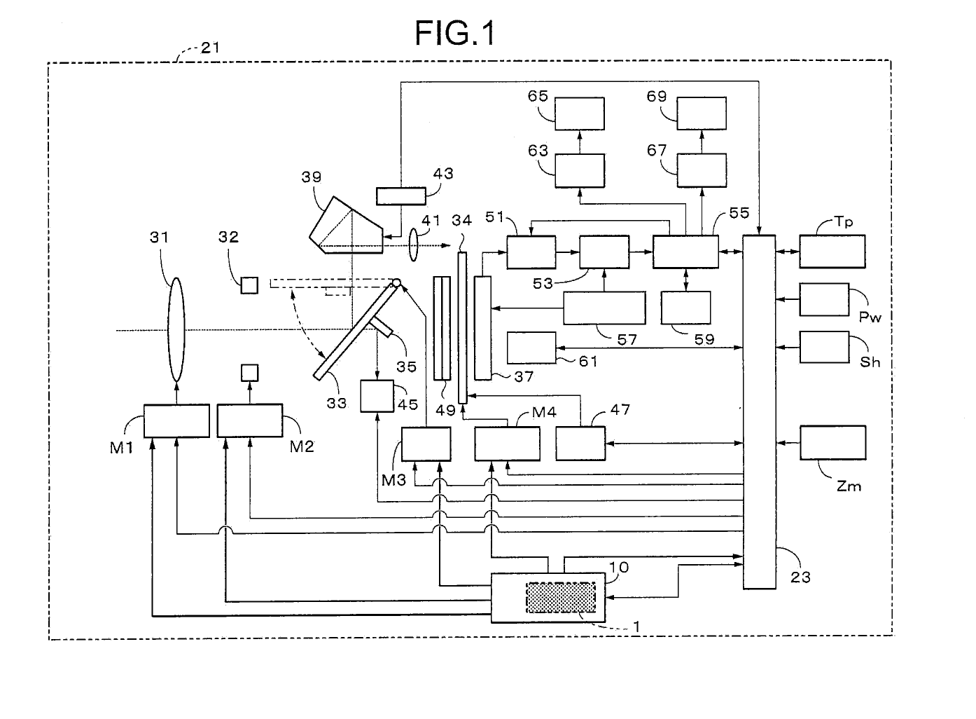

FIG. 1 is a block diagram showing a configuration example of an imaging apparatus according to an embodiment.

As shown in FIG. 1, an imaging apparatus 21 includes a power supply unit 10 having a power supplying apparatus 1, a control unit 23, and one or more motors. FIG. 1 shows a configuration example in which the imaging apparatus 21 includes a motor M1 for driving a lens 31, a motor M2 for driving a diaphragm 32, a motor M3 for driving a mirror 33, and a motor M4 for driving a shutter 34. It should be noted that the power supply unit 10 may be configured as an attachment that is replaceable with respect to the imaging apparatus 21.

Although the configuration example shown in FIG. 1 is an example in which the imaging apparatus 21 is configured as a digital single lens reflex camera, the example of the imaging apparatus is not limited to the digital single lens reflex camera. As long as the imaging apparatus has the battery as the power source and includes one or more motors, a technology of the present disclosure can be applied. The technology of the present disclosure can also be applied to an analog camera.

Hereinafter, referring to FIG. 1, the power supply unit 10, the control unit 23, and the motors M1, M2, M3, and M4 will be described in this order.

### (Power Supply Unit)

The power supply unit 10 supplies power necessary for each component of the electronic apparatus. For example, the power supply unit 10 supplies the power to the motors (described later), the control unit 23 (described later) and the like.

The power supply unit 10 includes the battery and the power supplying apparatus 1, for example.

The power supplying apparatus 1 includes a capacitor, a voltage control apparatus, a current limiting circuit, and first and second switching elements. The power supplying apparatus 1 is connected, for example, between the battery arranged to the power supply unit 10 and the load circuit including the motor. The power supplying apparatus 1 will be described in detail later.

### (Control Unit)

The control unit 23 is a processing apparatus including a processor, and is constituted, for example, as a digital signal processor (DSP) or a CPU, and controls each component of the imaging apparatus 21.

The control unit 23 monitors the capacity of the battery arranged to the power supply unit 10, transmits a drive signal to one or more motors (described later), performs arithmetic processing of an input signal from an imaging device 37, and calculates an exposure amount and a focus amount, for example. Moreover, the control unit 23 performs on/off control of the first and second switching elements in the power supplying apparatus 1.

### (Motor)

Actuators for executing various operations such as an auto focus operation, a diaphragm operation, a retraction operation and a return operation of a mirror 33, and a shutter operation are mounted on the imaging apparatus 21. For example, motors are used to drive these actuators.

The motors M1, M2, M3, and M4 shown in FIG. 1 form a part of a lens drive mechanism, a part of a diaphragm drive mechanism, a part of a mirror drive mechanism, and a part of a shutter drive mechanism (a shutter charging mechanism). Of course, the number of motors is not limited. For example, the imaging apparatus 21 may further include a motor that drives the actuator for image stabilization.

### OPERATION OF IMAGING APPARATUS

Herein, the operation of the imaging apparatus 21 will be briefly described.

First, when a power supply button Pw is turned on by the user of the imaging apparatus 21, supply of power from the battery arranged to the power supply unit 10 is started, and the power is supplied to each portion of the imaging apparatus 21 including the control unit 23.

Light incident upon the imaging apparatus 21 through the lens 31 and the diaphragm 32 is reflected by the mirror 33 and is then guided to a pentaprism 39. The light guided to the pentaprism 39 is repeatedly reflected in the pentaprism 39 and is then emitted toward an eyepiece 41. The user of the imaging apparatus 21 can check an image capturing target through the eyepiece 41 arranged to a viewfinder.

Part of the light guided to the pentaprism 39 is guided to a photometric sensor 43. An output from the photometric sensor 43 becomes an input for calculating an exposure amount by the control unit 23.

When the mirror 33 is a half mirror, the light passing through the mirror 33 is reflected by a sub mirror 35 and is guided to an autofocus sensor 45. An output from the autofocus sensor 45 becomes an input for calculating a focus amount by the control unit 23.

Next, when a shutter button Sh is pressed by the user, the control unit 23 transmits a control signal to the mirror drive mechanism and the motor M3 is driven. For example, driving the motor M3 flips up the mirror 33 and the light incident upon the imaging apparatus 21 is guided to the imaging device 37.

Moreover, the control unit 23 transmits the control signal to a shutter control circuit 47 and drives the motor M4. Driving the motor M4 rolls up a shutter screen and the light incident upon the imaging apparatus 21 reaches the imaging device 37 such as a charge-coupled device (CCD) and a complementary metal-oxide semiconductor (CMOS) through an optical filter 49.

Instead of pressing the shutter button Sh, the motor M3, the motor M4, and the like may be driven by an input from a touch panel Tp.

An electric signal obtained by a photoelectric conversion by the imaging device 37 is inputted to the control unit 23 through an amplifier 51, an analog-to-digital conversion circuit 53, an image data controller 55, and the like. It should be noted that a timing pulse generating circuit 57, an image memory 59, and a temperature sensor 61 shown in FIG. 1 are not indispensable for the present disclosure and thus descriptions thereof are omitted.

The image signal processed by the control unit 23 is transmitted to a display 65 such as a liquid crystal display (LCD) and an organic EL (electroluminescence effect) display through a driver 63, for example. Moreover, for example, according to an instruction of the user, the image signal is transmitted to an image data recording medium 69 through an image recording circuit 67 and is stored as image data.

It should be noted that in the image capturing, the control unit 23 transmits the control signal to the lens drive mechanism and the diaphragm drive mechanism based on the calculated exposure amount and focus amount. The motor M1 of the lens drive mechanism and the motor M2 of the diaphragm drive mechanism are driven, so that a position (focus) and a diaphragm of the lens 31 are adjusted. The adjustment of the focus and the diaphragm may be automatically executed by control of the control unit 23 or may be executed according to the instruction of the user.

As described later, in the present disclosure, power necessary at the initial stage of driving the motors M1, M2, M3, or M4 is supplied from the capacitor of power supplying apparatus 1. Therefore, at the initial stage of applying the voltage to the motor, a large current does not flow from the battery as the initial current.

### CONFIGURATION OF POWER SUPPLYING APPARATUS

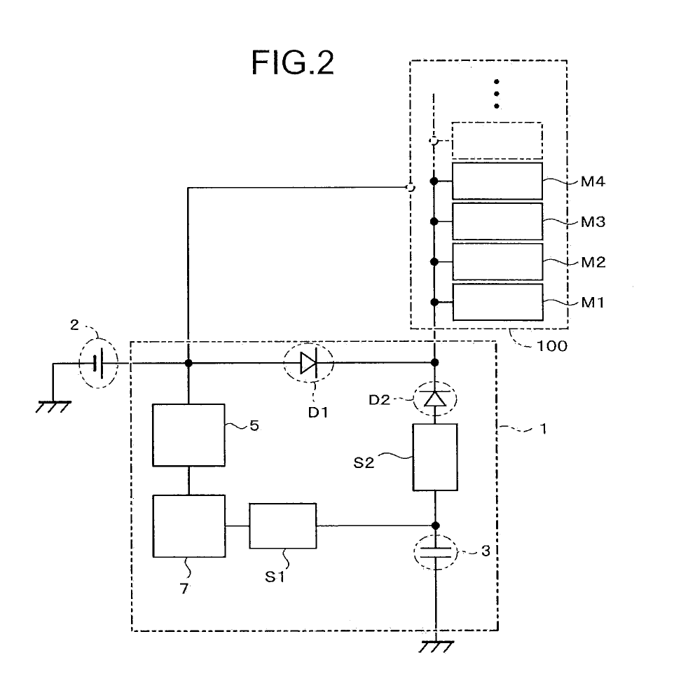

FIG. 2 is a block diagram showing a configuration example of the power supplying apparatus according to the embodiment.

As shown in FIG. 2, the power supplying apparatus 1 includes a capacitor 3, a voltage control apparatus 5, a current limiting circuit 7, a switching element S1, and a switching element S2.

The power supplying apparatus 1 is connected, for example, between a battery 2 arranged to the power supply unit 10 and a load circuit 100 including one or more motors. FIGS. 1 and 2 show examples in which four motors are included in the load circuit 100, but the number of motors is not limited to this. Of course, four or more motors may be used. The power supplying apparatus 1 is a power supplying apparatus favorable for use in the electronic apparatus including at least one motor in the load circuit.

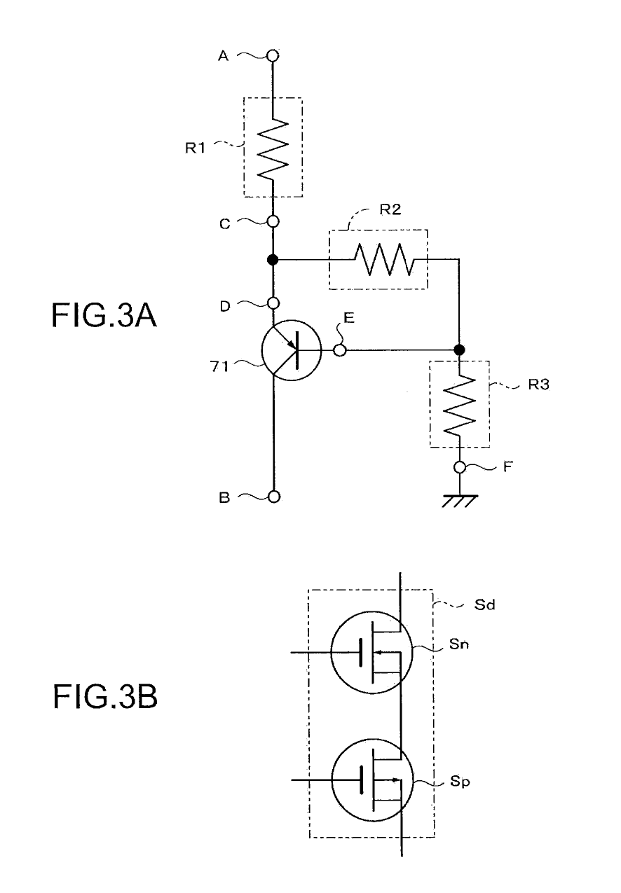

Hereinafter, referring to FIGS. 2, 3A, and 3B, the capacitor 3, the voltage control apparatus 5, the current limiting circuit 7, the switching element S1, and the switching element S2 will be described in this order.

### (Capacitor)

When at least one of the one or more motors included in the load circuit 100 is driven, the capacitor 3 is a capacitor for supplying power to the motor to be driven at the start of operating the motor to be driven.

Specifically, the capacitor 3 includes, for example, an electric double layer capacitor, a ceramic capacitor, a film capacitor, an aluminum electrolytic capacitor, a tantalum capacitor, a nanogate capacitor (the “nanogate” is a registered trademark of Nanogate Aktiengesellschaft), a lithium-ion capacitor, and a polyacenic semiconductor (PAS) capacitor.

In view of a low internal resistance and a magnitude of capacitance, the electric double layer capacitor is favorably selected as the capacitor 3. This is because the capacitor can be charged or discharged rapidly by providing the capacitor 3 with a very small internal resistance. Moreover, this is because one capacitor can drive a plurality of motors by providing the capacitor 3 with a sufficiently large capacity.

As shown in FIG. 2, the capacitor 3 is connected in parallel with the battery 2 arranged to the power supply unit 10. A high potential side of the battery 2 and a high potential side of the capacitor 3 are connected through the voltage control apparatus 5 (described later) and the current limiting circuit 7 (described later). That is, the capacitor 3 is charged by the battery 2 through the voltage control apparatus 5 and the current limiting circuit 7.

Since the high potential side of the battery 2 and the high potential side of the capacitor 3 are connected through the voltage control apparatus 5 and the current limiting circuit 7, the type of the battery 2 is not particularly limited. For example, a secondary battery or a primary battery such as a lithium-ion battery can be used as the battery 2.

### (Voltage Control Apparatus)

The voltage control apparatus 5 is a control apparatus for controlling, at a constant voltage, a voltage for charging the capacitor 3. As shown in FIG. 2, the voltage control apparatus 5 is connected in series between the battery 2 and the current limiting circuit 7 (described later), for example. As a place for connecting the voltage control apparatus 5, the voltage control apparatus 5 may be arranged in other places as long as the voltage control apparatus 5 is arranged between the battery 2 and the capacitor 3.

Specifically, as the voltage control apparatus 5, a DC-DC converter can be used. As the DC-DC converter, any of the DC-DC converters including a step-up type, a step-up-and-down type, and a step-down type can be used.

In view of providing the voltage for charging the capacitor 3 with a voltage higher than the terminal voltage of the battery, it is favorable that the step-up type or the step-up-and-down type DC-DC converter is selected as the voltage control apparatus 5. For example, the capacitor 3 is charged by the battery 2 through the step-up type DC-DC converter, so that the voltage for charging the capacitor 3 can be set to a voltage higher than the terminal voltage of the battery 2. Moreover, for example, the capacitor 3 is charged by the battery 2 through the step-up-and-down type DC-DC converter, so that the capacitor 3 can be stably charged at a constant voltage even if the terminal voltage of the battery 2 is decreased for some reason.

The capacitor 3 is charged through the voltage control apparatus 5, so that the output voltage of the capacitor 3 after being charged does not depend on the terminal voltage of the battery 2 during charge. Therefore, the operation of the motor to be driven is stable at the start of operating the motor to be driven. Moreover, since the capacitor 3 can be stably charged at a voltage higher than the terminal voltage of the battery 2 during charge, the operation of the motor to be driven is rapid and stable at the start of operating the motor to be driven.

The voltage applied to the motor is set to a voltage higher than the terminal voltage of the battery, which makes it possible to increase the r.p.m. of the motor and therefore to increase a torque of the motor to be driven in comparison with the case of directly applying the output voltage of the battery. That is, it is possible to execute an auto focus, diaphragm adjustment, continuous shooting, image stabilization, and the like, rapidly.

### (Current Limiting Circuit)

The current limiting circuit 7 is a circuit for controlling a current amount to be supplied to the capacitor 3. As shown in FIG. 2, the current limiting circuit 7 is connected in series between the voltage control apparatus 5 and the switching element S1 (described later), for example. As a place for connecting the current limiting circuit 7, the current limiting circuit 7 may be arranged in other places as long as the current limiting circuit 7 is arranged between the battery 2 and the capacitor 3.

The current limiting circuit 7 is not particularly limited. Various configurations can be applied. For example, as the current limiting circuit 7, a constant current circuit connected in series with a resistor for limiting the current, a constant current circuit in which a transistor and the resistor are combined, and a constant current circuit in which the transistor, the resistor, and an operational amplifier are combined can be used.

FIG. 3A is a circuit diagram showing an example of the constant current circuit.

In the circuit shown in FIG. 3A, when a base of a transistor 71 is grounded, a potential of a D point in FIG. 3A is higher than that of an E point in FIG. 3A by an amount corresponding to a voltage V_{BE} between a base and an emitter of the transistor 71. Therefore, a magnitude of a current extracted from a B point in FIG. 3A is obtained by dividing, by a resistance of a resistor R1, a voltage value obtained by subtracting V_{BE} from a voltage value in an A point in FIG. 3A (a voltage value in a C point in FIG. 3A) and a desired magnitude of a current can be extracted from the B point in FIG. 3A by adjusting the resistance of the resistor R1.

In the present disclosure, the capacitor 3 is charged through the current limiting circuit 7. This is because if the capacitor 3 is charged not through the current limiting circuit 7 when an amount of electric charge accumulated in the capacitor 3 is small, an inrush current flows from the battery 2 to the capacitor 3 and an expected need of preventing momentary increase in the current flowing from the battery is not achieved.

For example, in a case where the electric double layer capacitor is used as the capacitor 3, the electric double layer capacitor has a very small internal resistance, so that a response speed is very high when an electric charge accumulated in the electric double layer capacitor is supplied to each device. However, when the internal resistance is very small, if the current amount during charge is not limited, the inrush current flows during an initial charging period, which results in increase in the current amount flowing from the battery.

According to the configuration of the present disclosure, since the capacitor 3 is charged through the current limiting circuit 7, it is possible to prevent generation of the inrush current during the initial charging period.

### (Switching Elements)

As shown in FIG. 2, the power supplying apparatus 1 includes the switching element S1 and the switching element S2. Hereinafter, the switching element S1 and the switching element S2 will be described in this order.

The switching element S1 is a switch for controlling a start and a stop of the charge of the capacitor 3.

Specifically, the switching element S1 is a transistor, for example, but is not limited to this. The transistor includes, for example, a bipolar transistor, a field effect transistor, and a static induction transistor.

As shown in FIG. 2, the switching element S1 is connected in series between the current limiting circuit 7 and the capacitor 3, for example. Of course, as a place for connecting the switching element S1, the switching element S1 may be arranged in other places as long as the switching element S1 can control the start and the stop of the charge of the capacitor 3.

For example, when the circuit shown in FIG. 3A is applied as the current limiting circuit 7, a switching element S3 for switching a ground or floating of the base of the transistor 71 may be arranged, for example, at an F point and the like in FIG. 3A as the switching element S1.

It should be noted that the start and the stop of the charge of the capacitor 3 are controlled by the control unit 23. That is, switching of the switching element S1 and the switching element S3 is controlled by the control unit 23.

The switching element S2 is a switch for controlling the start and the stop of supply of a current from the capacitor 3 with respect to the motor included in the load circuit 100.

As shown in FIG. 2, the switching element S2 is connected in series between a terminal on the high potential side of the capacitor 3 and the load circuit 100, for example.

Specifically, the switching element S2 is a transistor, for example, but is not limited to this. The transistor includes, for example, the bipolar transistor, the field effect transistor, and the static induction transistor. Of course, the switching element S1 and the switching element S2 do not need to be the same kind of switching element.

For example, when a p-channel field effect transistor is arranged as the switching element S2, a forward direction of a parasite diode of the p-channel field effect transistor corresponds to a direction from the battery 2 toward a terminal on the high potential side of the capacitor 3. Therefore, for example, in a case where the p-channel field effect transistor is arranged as the switching element S2, when the amount of electric charge accumulated in the capacitor 3 is small, the current from the battery 2 may directly flow into the capacitor 3. For example, in a case where an attempt is made to supply power to the motor included in the load circuit 100 from the battery 2 and connection is made between the battery 2 and the motor, when the amount of electric charge accumulated in the capacitor 3 is small, the current from the battery 2 directly flows into the capacitor 3.

Therefore, for example, in a case where the p-channel field effect transistor is arranged as the switching element S2, a rectifying element D2 is favorably connected in series between the terminal on the high potential side of the capacitor 3 and the motor included in the load circuit 100. As the rectifying element D2, for example, a PN-junction diode or a Schottky barrier diode that has a relatively small voltage drop can be used. The forward direction of the diode at this time is a direction from the terminal on the high potential side of the capacitor 3 toward the motor included in the load circuit 100.

Alternatively, when the p-channel field effect transistor is arranged between the terminal on the high potential side of the capacitor 3 and the motor included in the load circuit 100, the switching element 2 is favorably a bi-directional switch. A bi-directional switch Sd shown in FIG. 3B is a switching element in which an n-channel field effect transistor is connected in series with the p-channel field effect transistor connected between the terminal on the high potential side of the capacitor 3 and the motor included in the load circuit 100. At this time, both of drains or sources of an n-channel field effect transistor Sn and a p-channel field effect transistor Sp are connected. In the present disclosure, a set of the p-channel and n-channel field effect transistors serially connected so that both of drains or sources are connected is referred to as a “bi-directional switch.”

It should be noted that the start and the stop of supply of a current from the capacitor 3 with respect to the motor included in the load circuit 100 are controlled by the control unit 23. That is, as with the switching of the switching element S1, switching of the switching element S2 is controlled by the control unit 23.

FIG. 2 shows a configuration example of further connecting between the battery 2 and the motor included in the load circuit 100 through a rectifying element D1. As with the rectifying element D2, for example, the PN-junction diode or the Schottky barrier diode that has a relatively small voltage drop can be used as the rectifying element D1. The forward direction of the diode at this time is a direction from the battery 2 toward the motor included in the load circuit 100.

By connecting between the battery 2 and the motor included in the load circuit 100 through the rectifying element D1, the amount of electric charge accumulated in the capacitor 3 is reduced and the battery 2 can supply power to the motor in the load circuit 100 even when the output voltage of the capacitor 3 is decreased.

For example, when the user performs continuous shooting continuously for several minutes to drive the shutter driving motor M4 continuously and the user repeats zoom-in or zoom-out for several minutes to drive the lens driving motor M1 continuously, the amount of electric charge accumulated in the capacitor 3 is rapidly reduced. When a balance between the charge to the capacitor 3 and the discharge from the capacitor 3 is lost, the motor included in the load circuit 100 is not driven by the capacitor 3 in some cases.

When the rectifying element D2 is arranged between the terminal on the high potential side of the capacitor 3 and the motor and the rectifying element D1 is arranged between the battery 2 and the motor, power is supplied from a high output voltage side out of the battery 2 or the capacitor 3 with respect to the motor in the load circuit 100. Therefore, even when the user makes special use of the imaging apparatus 21 and the output voltage of the capacitor 3 is decreased, it is possible to supply the power from the battery 2 to the motor included in the load circuit 100 and prevent a phenomenon that the motor does not drive.

Further, since the power is automatically supplied from the high output voltage side out of the battery 2 or the capacitor 3 to the motor included in the load circuit 100, the output voltage of the capacitor 3 does not need to be monitored. Therefore, a circuit size of the power supplying apparatus 1 can be reduced.

It should be noted that in the above case, since the power is supplied from the battery 2 to the motor, the current flowing from the battery 2 is increased. However, such a special case is extremely rare, and the stop voltage of the imaging apparatus 21 only needs to be temporarily increased.

### ANOTHER CONFIGURATION EXAMPLE OF POWER SUPPLYING APPARATUS

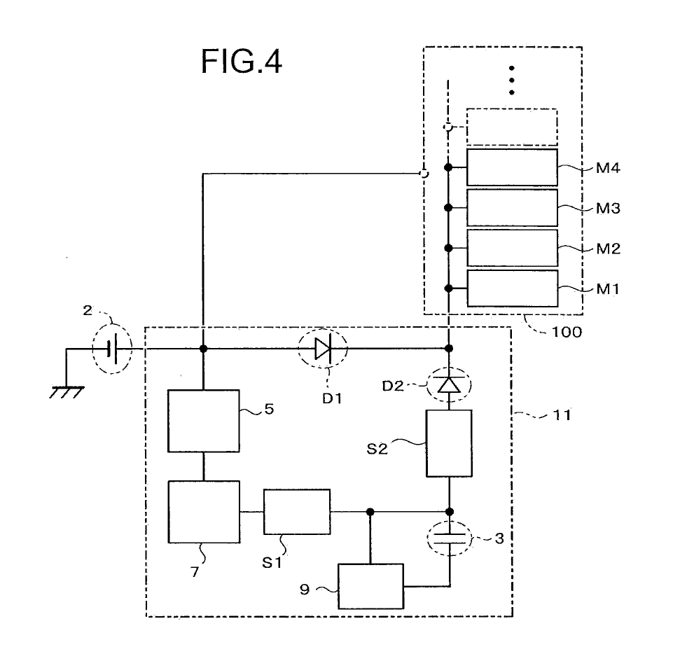

FIG. 4 is a block diagram showing another configuration example of the power supplying apparatus according to the embodiment.

In a power supplying apparatus 11 shown in FIG. 4, a terminal on a low potential side of the capacitor 3 is connected to an output terminal of a low drop out (LDO) regulator 9. That is, a reference potential of the capacitor 3 is equal to an output potential of the low drop out regulator 9.

Instead of setting the reference potential of the capacitor 3 to a ground potential, the reference potential of the capacitor 3 is favorably set to a lower potential than a potential on an output side of the current limiting circuit 7 by an amount corresponding to a constant voltage. There are two reasons for this. The reasons will be explained one by one below.

The first reason is that the output voltage of the capacitor at the end of discharge depends on the reference potential of the capacitor.

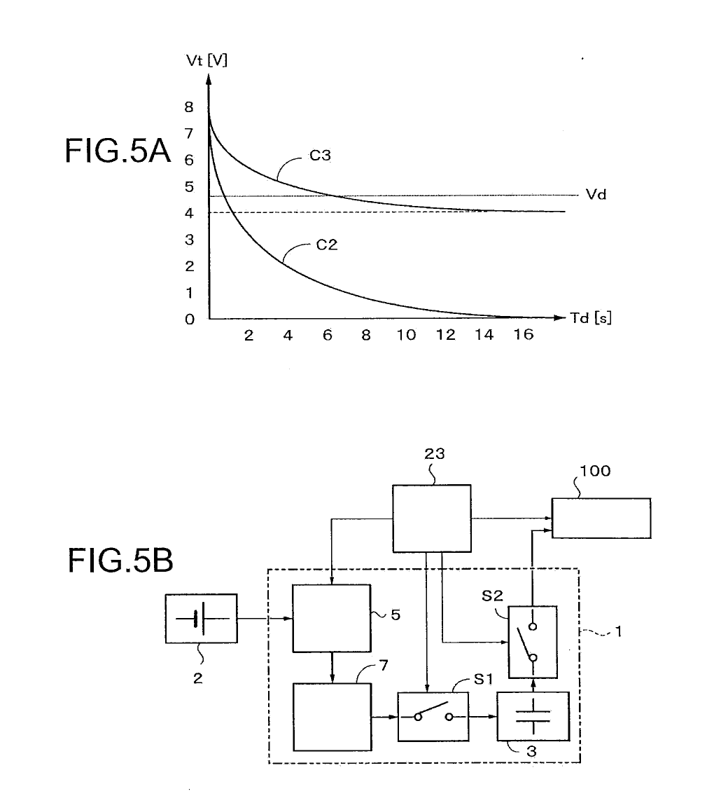

FIG. 5A is a diagram showing an example of a discharge curve of the capacitor. In FIG. 5A, a vertical axis represents a terminal voltage Vt [V] of the capacitor and a horizontal axis represents a time Td [s] when a current is extracted from the capacitor. A curve C2 in FIG. 5A indicates a discharge curve when a charging voltage is 8 [V] and a reference potential of the capacitor is a ground potential. A curve C3 in FIG. 5A indicates a discharge curve when the charging voltage is 8 [V] and the reference potential of the capacitor is a constant potential Vg (Vg>0[V]). The curve C3 corresponds to a discharge curve when a terminal on a low potential side of the capacitor is connected to an output terminal of the low drop out regulator.

As shown in FIG. 5A, the terminal voltage of the capacitor is decreased as an amount of electric charge accumulated is reduced due to discharge. In the case where the reference potential of the capacitor is the ground potential, the terminal voltage is 0 [V] when the capacitor is completely discharged. On the other hand, in the case where the reference potential of the capacitor is Vg, the terminal voltage is Vg [V] when the capacitor is completely discharged. That is, by connecting the terminal on the low potential side of the capacitor to the output terminal of the low drop out regulator, even when the amount of electric charge accumulated in the capacitor is reduced, a higher potential can be maintained as the terminal voltage.

In this case, provided that the lowest voltage at which the motor can be driven is Vd (Vd<8[V]), a range of the terminal voltage at which the motor can be driven by the capacitor is in a range of Vd [V] to 8 [V].

Comparing the curve C2 with the curve C3, when the reference potential of the capacitor is the ground potential, it can be seen that the terminal voltage is decreased to Vd and the motor is not driven by the capacitor even if the reduction amount of electric charge accumulated in the capacitor is small. On the other hand, when the reference potential of the capacitor is Vg, it can be seen that the motor can be driven by the capacitor for longer period of time even if the amount of electric charge accumulated in the capacitor is reduced.

The second reason is that it is necessary that the voltage applied to terminals at the both ends of the capacitor does not exceed a withstand voltage of the capacitor.

In particular, when the electric double layer capacitor is used as the capacitor, it is necessary that a voltage applied to terminals at the both ends of the electric double layer capacitor does not exceed a voltage at which electrolysis of an electrolyte solution starts.

A nominal voltage of a lithium-ion battery is about 4.0 [V]. Suppose now the withstand voltage of the capacitor is 5 [V]. There is no problem in charging the capacitor by the lithium-ion battery of one cell. However, when lithium-ion battery is connected in series and the capacitor is attempted to be charged by the lithium-ion battery of two cells, the voltage applied to terminals at the both ends of the capacitor is 8.0 [V] and exceeds 5 [V] that is the withstand voltage of the capacitor.

To prevent the voltage applied to terminals at the both ends of the capacitor from exceeding the withstand voltage of the capacitor, for example, a plurality of capacitors has to be connected in series.

However, when the plurality of capacitors are connected in series, if there is difference between the capacitors, the voltage applied to terminals at the both ends of some of the capacitors may exceed the withstand voltage of the capacitors. Moreover, when the plurality of capacitors are attempted to be connected in series, the number of components is increased and volumes occupied by the plurality of capacitors are also increased. That is, it is also difficult to downsize the mobile electronic apparatus and a manufacturing cost is also increased.

Accordingly, suppose the reference potential of the capacitor is, for example, Vg=4 [V] by connecting the terminal on the low potential side of the capacitor to the output terminal of the low drop out regulator. Then, the range of the voltage applied to terminals at the both ends of the capacitor is suppressed in a range of 8 [V]−4 [V]=4 [V] and the range of the voltage applied to terminals at the both ends of the capacitor does not exceed 5 [V] that is the withstand voltage of the capacitor.

Therefore, by connecting the terminal on the low potential side of the capacitor 3 to the output terminal of the low drop out regulator 9, it is possible to suppress decrease in the output voltage of the capacitor 3 with reduction of an amount of electric charge accumulated in the capacitor 3. Since the decrease in the output voltage of the capacitor 3 is suppressed with the reduction of the amount of electric charge accumulated in the capacitor 3, the electric charge accumulated in the capacitor 3 can be efficiently used.

Moreover, by connecting the terminal on the low potential side of the capacitor 3 to the output terminal of the low drop out regulator 9, a potential difference between a negative electrode and a positive electrode of the capacitor 3 can be reduced. Since the potential difference between the negative electrode and the positive electrode of the capacitor 3 is reduced, the capacitor 3 can be charged by the lithium-ion battery of two cells or the like having a higher output voltage even if the capacitor has a relatively small withstand voltage.

Since the potential difference between the negative electrode and the positive electrode of the capacitor 3 is reduced, the electric double layer capacitor can be easily applied as the capacitor 3 and the power supplying apparatus can be downsized while a size of the capacitor 3 is reduced.

### EXAMPLE CONTROL

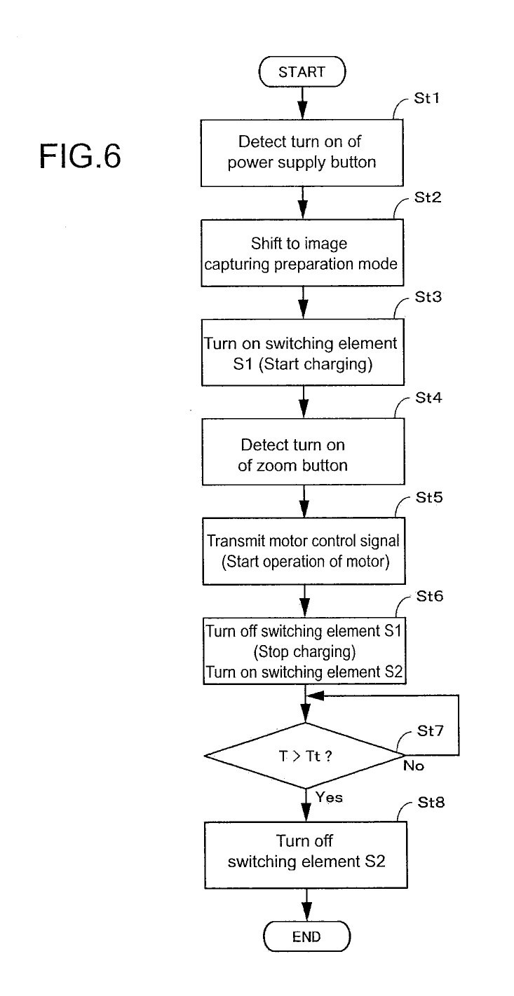

Next, referring to FIGS. 5B to 6, an example of control in the imaging apparatus including the power supplying apparatus of the present disclosure will be described.

FIG. 5B is a block diagram for explaining an example of control of the power supplying apparatus by the control unit.

As described above, the power supplying apparatus 1 is connected, for example, between the battery 2 arranged to the power supply unit 10 and the load circuit 100 including the one or more motors. Moreover, the voltage control apparatus 5, the switching element S1 and the switching element S2 of the power supplying apparatus 1, and each motor included in the load circuit 100 are controlled by the control unit 23.

The control unit 23 transmits the control signal to the voltage control apparatus 5, thereby controlling a start or a stop of the voltage control apparatus 5. The control unit 23 transmits a switching control signal to the switching element S1, thereby controlling the start or the stop of charge to the capacitor 3. The control unit 23 transmits the switching control signal to the switching element S2, thereby controlling the start and the stop of supply of a current from the capacitor 3 to the motor included in the load circuit 100. Moreover, the control unit 23 transmits a motor control signal to the motor included in the load circuit 100, thereby controlling the start or the stop of driving each motor included in the load circuit 100.

FIG. 6 is a flowchart showing a flow of processing by the control unit.

First, in step St1, when the power supply button Pw is turned on by the user of the imaging apparatus 21, the battery 2 arranged to the power supply unit 10 supplies power to the IC of the control unit 23 and the IC of the control unit 23 is started, for example. When the IC of the control unit 23 is started, the IC of the control unit 23 transmits the control signal to the voltage control apparatus 5, thereby starting the voltage control apparatus 5.

At this stage, the switching element S1 is turned off and the capacitor 3 is not charged.

Next, in step St2, the control unit 23 shifts a mode of the imaging apparatus 21 to an “image capturing preparation mode.” In this case, the “image capturing preparation mode” stands for a state where a still image and a moving image can be captured immediately by pressing the shutter button Sh.

For example, after the power supply button Pw is turned on by the user, the control unit 23 executes a shift to the image capturing preparation mode after a certain period of time has passed. Alternatively, for example, after the power supply button Pw is turned on by the user, the control unit 23 may shift the imaging apparatus 21 to the image capturing preparation mode in accordance with the operation of the user.

Next, in step St3, the switching control unit 23 transmits the control signal to the switching element S1 and turns on the switching element S1.

When the switching element S1 is turned on, the capacitor 3 is charged by the battery 2 connected in parallel with the capacitor 3. The capacitor 3 is charged during the stop of discharging the capacitor 3 through the voltage control apparatus 5 and the current limiting circuit 7.

It should be noted that when the electric double layer capacitor is used as the capacitor 3, it is favorable that the application time of the voltage for capacitor 3 is set to be shorter. This is because an internal electrolyte solution of the electric double layer capacitor evaporates in a state where a constant voltage is continuously applied, and its performance deteriorates.

Therefore, for example, the control unit 23 may cause the switching element S1 to turn on when the imaging apparatus 21 is in the image capturing preparation mode and may cause the switching element S1 to turn off when the user receives an input signal for reproducing an image data on the imaging apparatus 21.

Next, in step St4, suppose a zoom button Zm is pressed by the user, for example. The control unit 23 receives an instruction of zoom-in or zoom-out by the user as the input signal.

Next, in step St5, the control unit 23 transmits the motor control signal to the motor M1 for driving the lens 31.

Next, in step St6, the control unit 23 transmits the switching control signal to the switching element S1 and turns off the switching element S1. Moreover, the control unit 23 transmits the switching control signal to the switching element S2 and turns on the switching element S2.

Therefore, while the charge for the capacitor 3 is terminated, the capacitor 3 starts supplying a current to the motor included in the load circuit 100.

Thus, transmittance of the motor control signal for starting driving each motor included in the load circuit 100, transmittance of the switch control signal for stopping the charge for the capacitor 3, and transmittance of the switch control signal for starting the discharge from the capacitor 3 are synchronized. In other words, the start of driving each motor included in the load circuit 100 is synchronized with the stop of the charge for the capacitor 3 and the start of the discharge from the capacitor 3.

Since the start of driving each motor included in the load circuit 100 is synchronized with the stop of the charge to and the start of discharge from the capacitor 3, the capacitor 3 can supply a current to the motor included in the load circuit 100 at the initial stage of applying the voltage to the motor. Therefore, it is possible to reduce a maximum value of the current flowing from the battery without flowing a large current from the battery at the start of driving the motor.

It should be noted that a timing of stopping the discharge from the capacitor 3 can be arbitrarily set by a manufacturer of the power supplying apparatus or a manufacturer of the imaging apparatus. For example, the discharge from the capacitor 3 is stopped after a predetermined time has passed from the start of discharge from the capacitor 3.

For example, in step St7, the control unit 23 determines whether or not a time Tt in which the large current is necessary for driving the motor has passed from the start of discharge from the capacitor 3. It should be noted that the time Tt in which the large current is necessary for driving the motor is a time corresponding to 0 [h] to Th [h] shown in FIG. 7.

When the time Tt in which the large current is necessary for driving the motor is passed from the start of discharge from the capacitor 3, processing proceeds to step St8 and the control unit 23 transmits the switching control signal to the switching element S2 and turns off the switching element S2.

As described above, the time in which the large current is necessary for driving the motor depends on the voltage applied to the motor, the wiring resistance of the motor, and the number of windings of the motor, but is generally a very short time of about several tens [ms]. Therefore, the manufacturer of the power supplying apparatus or the manufacturer of the imaging apparatus can set the timing of stopping the discharge from the capacitor 3 when a time of about several tens [ms] at which the large current is necessary for driving the motor has passed from the start of driving the motor.

The time when the capacitor 3 supplies power to the motor included in the load circuit 100 is set to the time of about several tens [ms] at which the large current is necessary for driving the motor, so that supply of power from the capacitor 3 can be suppressed to a minimum necessary level. Since the supply of power from the capacitor 3 is suppressed to a minimum necessary level, a relatively small capacitor with capacitance of about several hundreds [mF] can be used as the capacitor 3.

The imaging apparatus 21 includes the motor M2 for driving the diaphragm 32, the motor M3 for driving the mirror 33, the motor M4 for driving the shutter 34, and the like. The manufacturer of the power supplying apparatus or the manufacturer of the imaging apparatus can know the characteristics of each motor in advance.

Therefore, the manufacturer of the power supplying apparatus or the manufacturer of the imaging apparatus can individually set times up to the stop of discharging the motors M1, M2, M3, . . . to t1, t2, t3, . . . That is, the timing of stopping the discharge from the capacitor 3 can be set according to which of the motors is driven among the one or more motors included in the load circuit 100. It should be noted that since each portion of the imaging apparatus 21 is controlled by the control unit 23, the control unit 23 can determine, based on an input signal or the like from the user to the control unit 23, which of the motors is to be driven.

The times t1, t2, t3, . . . up to the stop of discharging the motors are set considering the capacitance or aged deterioration of the capacitor 3.

In this case, management from the start to the stop of discharging the motors can be executed on the basis of the times because the capacitor 3 is charged through the voltage control apparatus 5 and the voltage for driving the motor included in the load circuit 100 is constant.

Change in a current amount due to the drive of the motor depends on the voltage applied to the motor. Therefore, if the voltage supplied from the capacitor 3 for driving the motor is constant, it is possible to know an approximate peak current amount for driving the motor and an approximate time when the large current is necessary for driving the motor, in advance.

Executing the management from the start to the stop of discharging the motors on the basis of the times eliminates the need for measuring the current amount of the motors, thereby also eliminating the need for arranging current measuring circuits as many as the plurality of motors and facilitating downsizing of the circuit.

In a time from when the capacitor 3 stops supplying a current to the motor included in the load circuit 100 to when the drive of the motor is stopped, the capacitor 3 may be charged or the capacitor 3 does not need to be charged.

For example, the switching element S1 is set to be turned on by the timing of stopping the discharge from the capacitor 3 and the capacitor 3 may start charging. The timing of stopping the discharge to the capacitor 3 in this case can be set when the driving of the motor is stopped, for example.

The stop of discharge from the capacitor 3 is synchronized with the start of charging the capacitor 3, which therefore makes it possible to accumulate electric charge in the capacitor 3 before the next discharge. Accumulating electric charge in the capacitor 3 before the next discharge enables the capacitor 3 to reliably supply power to the motor and is advantageous in the case of repeating driving and stopping of the motor at short time intervals in continuous shooting, for example.

On the other hand, when, also in a period from when the capacitor 3 stops supplying the current to when the drive of the motor is stopped, the capacitor 3 is not charged, the battery 2 can avoid supplying power to both the motor and the capacitor 3 at the same time.

After a series of processing described above, suppose the shutter button Sh is pressed by the user, for example. Then, the control unit 23 transmits the control signal to the lens drive mechanism, the diaphragm drive mechanism, and the like, and drives the motor M1, the motor M2, and the like, thereby adjusting the focus, the diaphragm, and the like. The control when the control unit 23 drives the motor M1, the motor M2, and the like included in the load circuit is executed in a similar manner as the series of processing described above.

After the focus, the diaphragm, and the like are adjusted by the control unit 23, a retraction of the mirror 33, winding of the shutter 34, and imaging by the imaging apparatus are performed and a series of image capturing operations are completed. It is obvious that the control when the control unit 23 drives the motor M3 of the mirror drive mechanism, the motor M4 of the shutter drive mechanism, and the like is similar to the series of processing described above. Moreover, FIGS. 2, 4 and the like show examples in which one switching element is arranged between the capacitor 3 and the plurality of motors. However, the plurality of switching elements may be arranged corresponding to the plurality of motors, respectively.

After the series of image capturing operations are completed, for example, the processing is returned to step St2 and the imaging apparatus 21 is in the image capturing preparation mode again.

As described above, according to the present disclosure, the power necessary at the initial stage of driving the motor included in the load circuit is supplied from the capacitor of the power supplying apparatus. Therefore, at the initial stage of applying the voltage to the motor, the large current does not flow from the battery as the initial current and the momentary decrease in the terminal voltage of the battery can be prevented. According to the present disclosure, since the momentary decrease in the terminal voltage of the battery is prevented at the initial stage of applying the voltage to the motor, it is possible to set the stop voltage of the imaging apparatus to be lower and reduce waste of the capacity of the battery. That is, the driving time of the imaging apparatus is increased and the number of pictures that can be taken in the imaging apparatus is increased.

Moreover, according to the present disclosure, the capacitor is charged through the voltage control apparatus. Accordingly, the output voltage of the capacitor does not depend on the terminal voltage of the battery during charge and a fluctuation in the output voltage of the capacitor is prevented. Therefore, the capacitor can supply a constant voltage to the motor included in the load circuit, and a fluctuation in a focusing speed, an adjustment speed of the diaphragm, and a continuous shooting speed of the imaging apparatus can be prevented.

Further, according to the present disclosure, the capacitor is charged through the current limiting circuit. Therefore, the inrush current does not flow into the capacitor at the start of charging the capacitor 3 and the rapid decrease in the terminal voltage of the battery is prevented. Since the terminal voltage of the battery is not rapidly decreased even at the start of charging the capacitor, it is possible to set the stop voltage of the imaging apparatus to be lower.

When the terminal on the low potential side of the capacitor is connected to the output terminal of the low drop out regulator, it is possible to suppress decrease in the output voltage of the capacitor with reduction of the amount of electric charge accumulated in the capacitor. Therefore, the electric charge accumulated in the capacitor can be efficiently used.

### 2. MODIFIED EXAMPLES

Although, the favorable embodiment has been described above, favorable specific examples are not limited to the above examples and various modifications are possible.

The power supplying apparatus that is capable of keeping the driving speed of the actuator constant can be provided by applying the technology of the present disclosure, the actuator being provided to the mobile electronic apparatus. For example, the technology of the present disclosure can be applied to various electronic apparatuses including at least one motor in the load circuit. The electronic apparatus including at least one motor in the load circuit includes a computer and a server apparatus including a cooling fan, a disk drive, and the like, audio equipment, an electric bicycle, a portable vacuum cleaner, an electric power tool, and the like.

Although the above embodiment describes the configuration example in which the imaging apparatus is configured as the digital single lens reflex camera, the example of the imaging apparatus is not limited to the digital single lens reflex camera. Of course, for example, the technology of the present disclosure can be applied also to a camera mounted in a mobile phone, a smartphone, a laptop personal computer, a tablet personal computer, a personal digital assistance (PDA), or the like as the imaging apparatus.

Moreover, although the above embodiment describes the configuration example in which the power supplied from the capacitor is supplied only to the one or more motors included in the load circuit, the power supplied from the capacitor may be supplied to each portion such as the control unit of the electronic apparatus.

It should be noted that the configurations, methods, shapes, materials, numerical values, and the like described in the above embodiment are simply described by way of example, and whenever necessary, the configurations, methods, shapes, materials, numerical values, and the like different from those described above may be used. Also, the structures, methods, shapes, materials, numerical values, and the like in the above-described embodiment can be combined with each other without departing from the gist of the present disclosure.

For example, the present disclosure may be configured as follows.

(1) A power supplying apparatus, including:

a capacitor that is connected in parallel with a battery;

a voltage control apparatus configured to control a voltage for charging the capacitor;

a current limiting circuit configured to control a current amount to be supplied to the capacitor;

a first switching element configured to control supply of a current for charging the capacitor; and

a second switching element configured to control supply of a current from the capacitor to at least one motor.

(2) The power supplying apparatus according to Item (1), in which the capacitor is an electric double layer capacitor.

(3) The power supplying apparatus according to Item (1) or (2), in which the voltage control apparatus is one of a step-up type direct current to direct current (DC-DC) converter and a step-up-and-down type DC-DC converter.

(4) The power supplying apparatus according to any one of Items (1) to (3), further including a low drop out regulator, in which

the capacitor has a reference potential equal to an output potential of the low drop out regulator.

(5) The power supplying apparatus according to any one of Items (1) to (4), further including:

a first rectifying element configured to rectify a current from the battery;

a second rectifying element configured to rectify a current from the capacitor to the at least one motor, in which

the battery and the at least one motor are connected to each other through the first rectifying element.

(6) The power supplying apparatus according to any one of Items (1) to (4), further including

a first rectifying element configured to rectify a current from the battery, in which

the second switching element is a bi-directional switch, and

the battery and the at least one motor are connected to each other through the first rectifying element.

(7) A power supplying method, including:

turning on a first switching element during a stop of discharging a capacitor and charging the capacitor by a battery connected in parallel with the capacitor through a voltage control apparatus and a current limiting circuit; and

turning on a second switching element at a start of operating one of at least one motor included in a load circuit and supplying, from the capacitor, power to the motor caused to start operating.

(8) The power supplying method according to Item (7), in which a time from when the second switching element is turned on to when the second switching element is turned off is set according to which one of the at least one motor is operated.

(9) An imaging apparatus, including:

one or more motors configured to drive at least one of a lens, a diaphragm, a mirror, and a shutter;

a capacitor that is connected in parallel with a battery;

a voltage control apparatus configured to control a voltage for charging the capacitor;

a current limiting circuit configured to control a current amount to be supplied to the capacitor;

a first switching element configured to control supply of a current for charging the capacitor;

a second switching element configured to control supply of a current from the capacitor to the one or more motors; and

a control unit configured to control one of turn-on and turn-off of the first switching element and the second switching element.

The present disclosure contains subject matter related to that disclosed in Japanese Priority Patent Application JP 2011-220817 filed in the Japan Patent Office on Oct. 5, 2011, the entire content of which is hereby incorporated by reference.

What is claimed is:

1. A power supplying apparatus, comprising:
a capacitor that is connected in parallel with a battery;
a voltage control apparatus configured to control a voltage for charging the capacitor;
a current limiting circuit configured to control a current amount to be supplied to the capacitor;
a first switching element configured to control supply of a current for charging the capacitor; and
a second switching element configured to control supply of a current from the capacitor to at least one motor.

2. The power supplying apparatus according to claim 1, wherein
the capacitor is an electric double layer capacitor.

3. The power supplying apparatus according to claim 1, wherein
the voltage control apparatus is one of a step-up type direct current to direct current (DC-DC) converter and a step-up-and-down type DC-DC converter.

4. The power supplying apparatus according to claim 1, further comprising
a low drop out regulator, wherein
the capacitor has a reference potential equal to an output potential of the low drop out regulator.

5. The power supplying apparatus according to claim 1, further comprising:
a first rectifying element configured to rectify a current from the battery; and
a second rectifying element configured to rectify a current from the capacitor to the at least one motor, wherein
the battery and the at least one motor are connected to each other through the first rectifying element.

6. The power supplying apparatus according to claim 1, further comprising
a first rectifying element configured to rectify a current from the battery, wherein
the second switching element is a bi-directional switch, and
the battery and the at least one motor are connected to each other through the first rectifying element.

7. A power supplying method, comprising:
turning on a first switching element during a stop of discharging a capacitor and charging the capacitor by a battery connected in parallel with the capacitor through a voltage control apparatus and a current limiting circuit; and
turning on a second switching element at a start of operating one of at least one motor included in a load circuit and supplying, from the capacitor, power to the motor caused to start operating.

8. The power supplying method according to claim 7, wherein
a time from when the second switching element is turned on to when the second switching element is turned off is set according to which one of the at least one motor is operated.

9. An imaging apparatus, comprising:
one or more motors configured to drive at least one of a lens, a diaphragm, a mirror, and a shutter;
a capacitor that is connected in parallel with a battery;
a voltage control apparatus configured to control a voltage for charging the capacitor;
a current limiting circuit configured to control a current amount to be supplied to the capacitor;
a first switching element configured to control supply of a current for charging the capacitor;
a second switching element configured to control supply of a current from the capacitor to the one or more motors; and
a control unit configured to control one of turn-on and turn-off of the first switching element and the second switching element.
